(19) United States
(12) Patent Application Publication
(10) Pub. No.: US 2018/0188113 A1
(43) Pub. Date: Jul. 5, 2018

(54) COVER DEVICE AND METHOD FOR MEASURING HUE USING MOBILE DEVICE

(71) Applicant: PRINTING TECHNOLOGY RESEARCH INSTITUTE, NEW TAIPEI CITY (TW)

(72) Inventors: SHIH-CHANG CHANG, NEW TAIPEI CITY (TW); CHIA-PIN CHUEH, NEW TAIPEI CITY (TW); HAO-HUNG CHANG, NEW TAIPEI CITY (TW); SI-HENG CHEN, NEW TAIPEI CITY (TW)

(21) Appl. No.: 15/393,760

(22) Filed: Dec. 29, 2016

(51) Int. Cl. G01J 3/46; H04N 1/60; H04N 1/64; H04N 5/225; G01J 3/50; G06T 7/90; G06T 7/00

(52) U.S. Cl. CPC G01J 3/462; H04N 1/6075; H04N 1/644; H04N 5/225; H04N 5/2256; G06T 2207/30244; G06T 7/90; G06T 7/97; G06T 2207/10024; G06T 2207/20021; G01J 3/50

(57) ABSTRACT

The present invention provides a method and a cover device for measuring hue using a mobile device. After the camera unit of the mobile device acquires the ColorChecker image, the mobile device converts the color space of the image and measures the hues of the ColorChecker. In addition, while acquiring the ColorChecker image, the ColorChecker is placed in the cover device.

### FIELD OF THE INVENTION

The present invention relates generally to a method and a cover device for measuring hue, and particularly to a method and a cover device for measuring hue using a mobile device and further giving a color space.

### BACKGROUND OF THE INVENTION

Thanks to technological progresses, various printing apparatuses, such as inkjet printers or laser printers, become popular gradually, accord that the number of printing service providers such as advertisement studios or printing factories is gradually increasing. In the current model, firstly, customers will usually provide the image files to be printed. Then printing factories will input the image files to printing apparatuses for printing the final products according to the input files.

Normally, printing service providers own one or more printing apparatus. When a consumer needs massive printing, to increase the production rate of printed matters, the providers will input the image files provided by the consumer to one or more printing apparatus. Hence, the consumer can get the required printed matters soon. Nonetheless, due to differences in the brands, manufacturing time, usage time, and consumables of the printing apparatuses, the printed matters printed by different printing apparatuses differ in color. This differences in color are unacceptable for the consumers requiring accuracy in the color of printed matters. Thus, print color renderings of different printing apparatuses are different.

Currently, to solve the difference in the color of the printed matters produced by printing apparatuses, a ColorChecker will be first printed by the printing apparatuses. Then a scanner scans the color blocks on the ColorChecker and giving the hue of each color block. The scanned result is sent to a color meter to give the color characteristics of the printing apparatus printing the ColorChecker. Afterwards, the printing apparatus can be calibrated according to the acquired color characteristics of the printing apparatus. Unfortunately, the scanner needs to scan the respective color blocks individually. It takes a great deal of time before the hues of all color blocks on the ColorChecker are acquired completely. In addition, carrying a scanner is inconvenient. A scanner also requires the accompanying software for operation and the operating process is relatively complex and inconvenient.

### SUMMARY

An objective of the present invention is to provide a cover device and a method for measuring hue using a mobile device. After the camera unit of the mobile device acquiring the images of the ColorChecker, the hue values and the color space are given.

In order to achieve the above objective and efficacy, according to an embodiment of the present invention, the method for measuring hue using a mobile device comprises steps of: photographing a first ColorChecker image using a camera unit of a mobile device, and the ColorChecker including a plurality of color blocks; the mobile device converting the color space of the first ColorChecker image using a color-space conversion algorithm, and giving a second ColorChecker image; and the mobile device acquiring the pixel values of each color block in the second ColorChecker image.

According to an embodiment of the present invention, before the step of photographing the first ColorChecker image using the camera unit of the mobile device, the method further comprises a step of the mobile device aligning the ColorChecker according to a plurality of alignment marks on the ColorChecker.

According to an embodiment of the present invention, after the step of the mobile device acquiring the pixel values of each color block in the second ColorChecker image, the method further comprises a step of transmitting the pixel values of each color block to a server; the server using an algorithm to give the description information of color characteristics for the ColorChecker according the pixel values of each color block; and the server transmitting the description information of color characteristics to the mobile device.

According to an embodiment of the present invention, the ColorChecker is generated by the printing apparatus.

According to an embodiment of the present invention, the first ColorChecker image belongs to the RGB color space.

According to an embodiment of the present invention, the second ColorChecker image belongs to the CIE XYZ color space. The ColorChecker is placed in a cover device. The camera unit of the mobile device photographs the ColorChecker through the hole of the cover device.

According to an embodiment of the present invention, the cover device comprises a lighting device inside.

Furthermore, according to another embodiment of the present invention, the cover device comprises a base, a lid, a hood, and an accommodating space. The lid includes a hole. One or more lamp is disposed on one surface of the lid. The lid is located on the base and connected with the base via a plurality of supporting units. The supporting unit includes a first supporting member and a second supporting member. One end of the first supporting member is connected with one end of the second supporting member via a first pivoting member. The other end of the first supporting member is connected with the lid via a second pivoting member. The other end of the second supporting member is connected with the base via a third pivoting member. The hood is disposed between and connected with the base and the lid. The accommodating space is formed inside the cover device.

### BRIEF DESCRIPTION OF THE DRAWINGS

FIG. 1 shows a flowchart of the method for measuring hue using a mobile device according to the first embodiment of the present invention;

FIG. 2 shows a system schematic diagram of the method for measuring hue using a mobile device, according to the first embodiment of the present invention;

FIG. 3 shows a schematic diagram of the ColorChecker of the method for measuring hue using a mobile device according to the second embodiment of the present invention for illustrating that the ColorChecker includes a plurality of alignment marks;

FIG. 4 shows a flowchart of the method for measuring hue using a mobile device according to the third embodiment of the present invention;

FIG. 5 shows a system schematic diagram of the method for measuring hue using a mobile device according to the third embodiment of the present invention;

FIG. 6 shows a schematic diagram of the cover device in the method for measuring hue using a mobile device according to the fourth embodiment of the present invention;

FIG. 7 shows a schematic diagram of the cover device in the method for measuring hue using a mobile device according to the fourth embodiment of the present invention for illustrating that the cover device is foldable; and

FIG. 8 shows a schematic diagram of the cover device in the method for measuring hue using a mobile device according to the fourth embodiment of the present invention for illustrating that the cover device is foldable.

### DETAILED DESCRIPTION

In order to make the structure and characteristics as well as the effectiveness of the present invention to be further understood and recognized, the detailed description of the present invention is provided as follows along with embodiments and accompanying figures.

According to the prior art, it takes a great deal of time to scan the ColorChecker for acquiring hues. In addition, scanners are inconvenient for carrying. Thereby, the method for measuring hue using a mobile device is proposed.

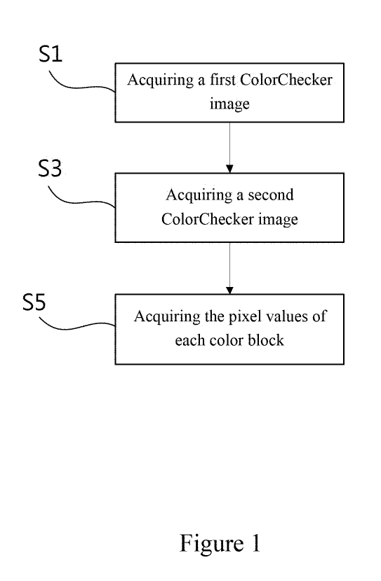

In the following, the flow of the method for measuring hue using a mobile device according to the first embodiment of the present invention will be described. Please refer to FIG. 1, which shows a flowchart of the method for measuring hue using a mobile device according to the first embodiment of the present invention. As shown in the figure, the method for measuring hue using a mobile device according to the present embodiment comprises steps of:

Step S1: Acquiring a first ColorChecker image;

Step S2: Acquiring a second ColorChecker image; and

Step S5: Acquiring the pixel values of each color block.

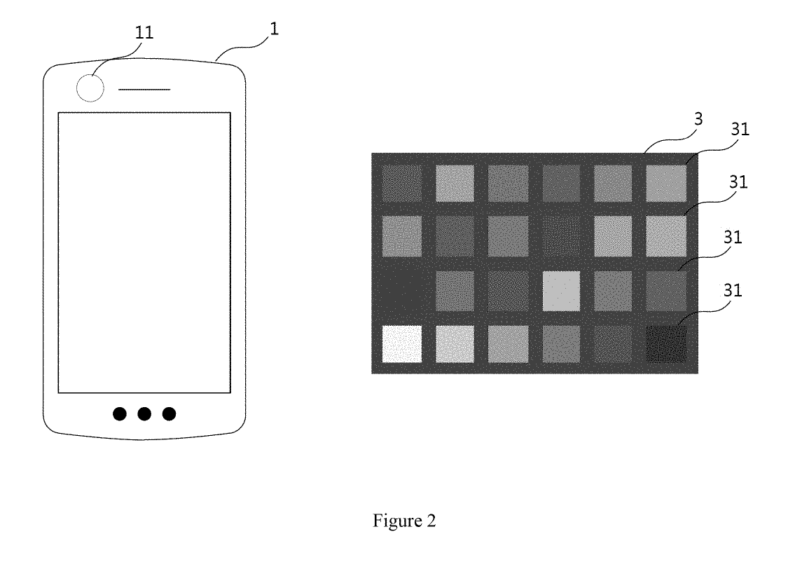

Next, the system required to achieve the method for measuring hue using a mobile device according to the present invention will be described. Please refer to FIG. 2, which shows a system schematic diagram of the method for measuring hue using a mobile device according to the first embodiment of the present invention. As shown in the figure, the system for the method for measuring hue using a mobile device according to the present invention comprises a mobile device 1 an a ColorChecker 3. The mobile device 1 includes a camera unit 11, and can be an electronic device such as a smartphone or a personal digital assistance (PDA). The ColorChecker 3 includes a plurality of color blocks 31 and is printed by a printing apparatus.

In the following, the flow for executing the method for measuring hue using a mobile device according to the first embodiment of the present invention will be described. Please refer to both FIG. 1 and FIG. 2. To measure hue, the steps S1 through S5 will be executed.

In the step S1 of acquiring a first ColorChecker image, the camera unit 11 of the mobile device 1 photographs the ColorChecker 3 for acquiring a first ColorChecker image. The first ColorChecker image belongs to the RGB color space. In other words, each pixel in the first ColorChecker image belongs to the RGB color space.

In the step S3 of acquiring a second ColorChecker image, the mobile device 1 converts the first ColorChecker image to the CIE XYZ color space using a color-space conversion algorithm for acquiring a second ColorChecker image. That is to say, each pixel in the second ColorChecker image belongs to the CIE XYZ color space.

In the step S5 of acquiring the pixel values of each color block, the mobile device 1 acquires the pixel values of each color block 31 in, the second ColorChecker. To elaborate, after the mobile device 1 acquires the location of each color block 31 in the second ColorChecker, it next acquires the pixel values of each color block 31. Because the second ColorChecker belongs to the CIE XYZ color space already, the acquired pixel values of each color block 31 belong to the CIE XYZ color space as well. The mobile device 1 acquire the location of each color block 31 by using the image identification algorithm, the grouping algorithm, or the clustering algorithm, or by setting the spacing between each pair of color blocks 31 in advance (for example, use the mobile device 1 to set the length and width of each color block 31 to be one pixel, respectively; two color blocks 31 are spaced by one pixel in length and width, respectively. When the first color block 31 is located at the (1,1) coordinates in the second ColorChecker image, the second color block 31 is located at the (3,1) coordinates in the second ColorChecker image.) Because the pixel value of the CIE XYZ color space represents the hue value of the pixel, the hue value of the ColorChecker 3 can be acquired according to the pixel value of each color block 31.

Up to now, the method for measuring hue using a mobile device according to the first embodiment of the present invention is completed. The camera unit 11 of the mobile device 1 can photograph the whole ColorChecker at a time to give the first ColorChecker image. Compared with scanning each color block 31 on the ColorChecker 3 using a scanner according to the prior art, the present method can acquire the hues of the ColorChecker 3 more rapidly.

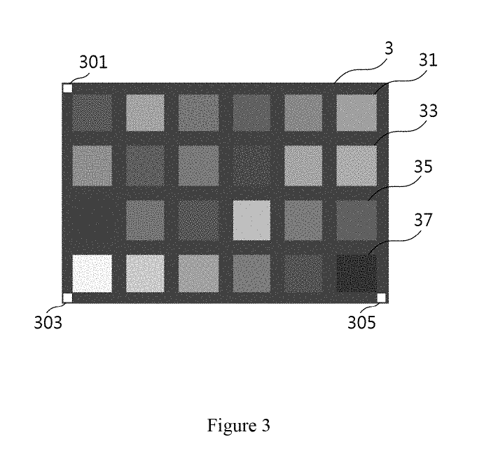

Next, the method for measuring hue using a mobile device according to the second embodiment of the present invention will be described. Please refer to FIG. 3. According to the present embodiment, the ColorChecker 3 further includes a plurality of alignment marks 301. The alignment marks 301 can be alignment marks identifiable by image identification methods, such as colors (for example, black), stripes, (for example, straight stripes), shapes (for example, triangles), symbols, or others.

According to the present embodiment, in the step S1, after the mobile device 1 acquires images via the camera unit 11, an image identification algorithm is adopted for giving the coordinates of the alignment marks 301. The mobile device 1 acquires the coordinates of the ColorChecker 3 according to the coordinates of the alignment marks 301. Then the camera unit 11 photographs to give the first ColorChecker image.

By using the present embodiment, accurate aiming at the ColorChecker by a user is not required while photographing one. Namely, alignment, calibration, and zooming is no longer required. Instead, once the ColorChecker is within the range of the camera unit 11 of the mobile device 1, the first ColorChecker image will be given, and thus bringing more convenience in usage.

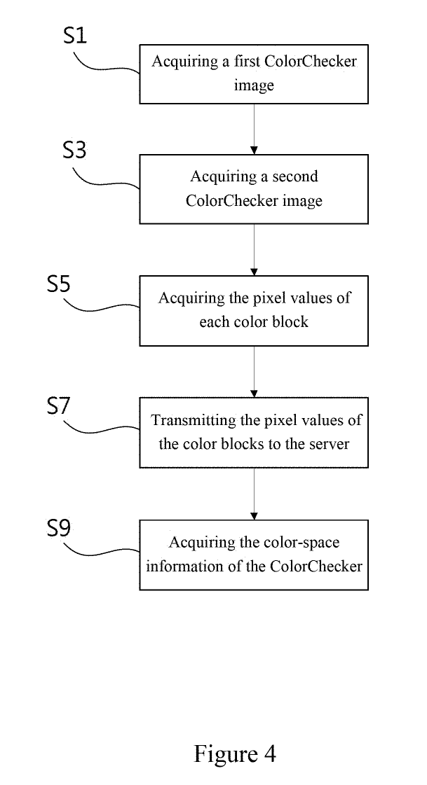

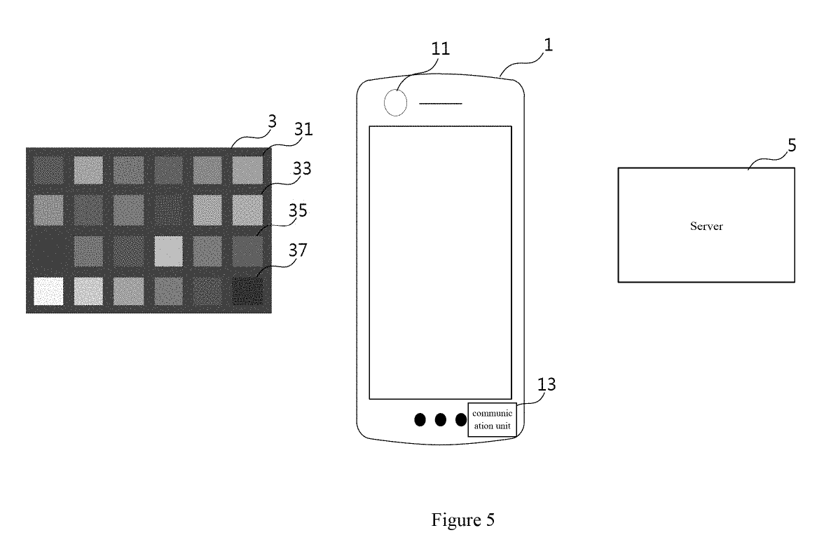

Next, the method for measuring hue using a mobile device according to the third embodiment of the present invention will be described. Please refer to FIG. 4 and FIG. 5. The difference between the present embodiment and the first one is that the flow of the present embodiment further comprises the steps S7 and S9. The system according to the present embodiment further comprises a server 5, which can be an electronic device such as a smartphone, a PDA, a tablet computer, a notebook computer, a desktop computer, or a workstation.

According to the present embodiment, in the step S7 of transmitting the pixel values of the color blocks 31 to the server 5, the mobile device 1 transmits the pixel values of the color blocks 31 to server 5 via a communication unit 13 in a wired or wireless method.

According to the present embodiment, in the step S9 of acquiring the color-space information of the ColorChecker, the server 5 acquires a piece of description information of color characteristics for the ColorChecker using an algorithm according to the pixel value of each color block 31 and transmits the acquired description information of color characteristics to the mobile device 1. The description information of color characteristics is the ICC Profile information.

Up to now, the method for measuring hue using a mobile device according to the third embodiment of the present invention is completed. By using the present embodiment, the acquired pixel values of the color blocks 31 are transmitted to the server 5. The server 5 can acquire the description information of color characteristics according to the pixel values of the color blocks 31 and transmits the description information of color characteristics to the mobile device 1. Then the printing apparatus can be calibrated using the description information of color characteristics.

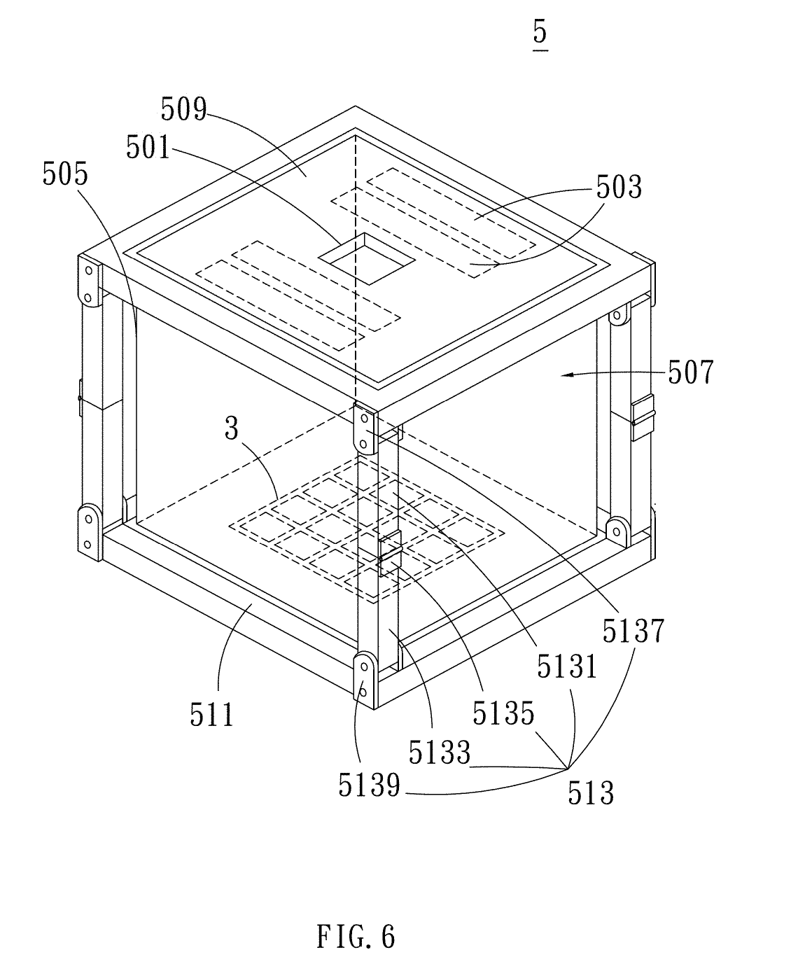

Next, the method for measuring hue using a mobile device according the fourth embodiment of the present invention will be described. Please refer to FIG. 6, which shows a schematic diagram of the cover device in the method for measuring hue using a mobile device according to the fourth embodiment of the present invention.

The cover device 5 comprises a hole 501, one or more lamp 503, a hood 505, an accommodating space 507, a lid 509, a base 511, and a plurality of supporting units 513.

The hole 501 described above is disposed at the lid 509.

The lid 509 is located above the base 511 and connected with the base 511 via a plurality of supporting units 513. The supporting unit 513 includes a first supporting member 5131 and a second supporting member 5133. One end of the first supporting member 5131 is connected with one end of the second supporting member 5133 via a first pivoting member 5135. The other end of the first supporting member 5131 is connected with the lid 509 via a second pivoting member 5137. The other end of the second supporting member 5133 is connected with the base 511 via a third pivoting member 5139.

The lamp 502 is disposed on the surface of the lid 509 facing the base 511. The lamp 503 can emit light with a color temperature of D50 or D65.

The hood 505 is disposed between the base 511 and the lid 509. The hood 505 is connected with the base 511 and the lid 509, and is made of opaque and flexible materials.

The ColorChecker 3 is placed in the accommodating space 507 formed in the cover device 5.

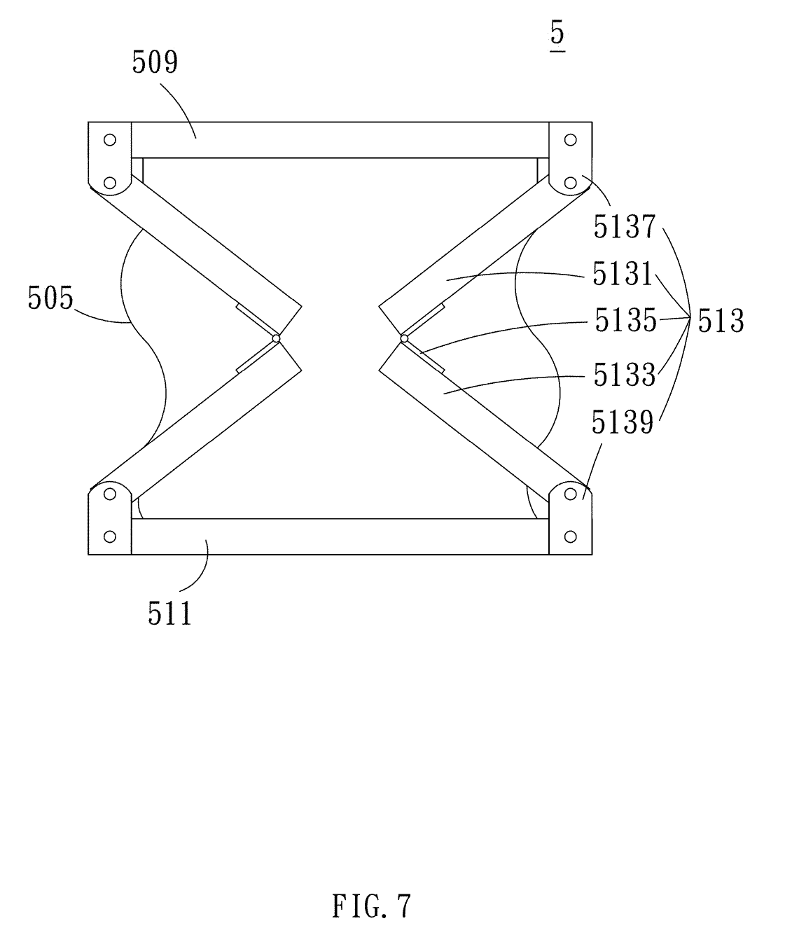

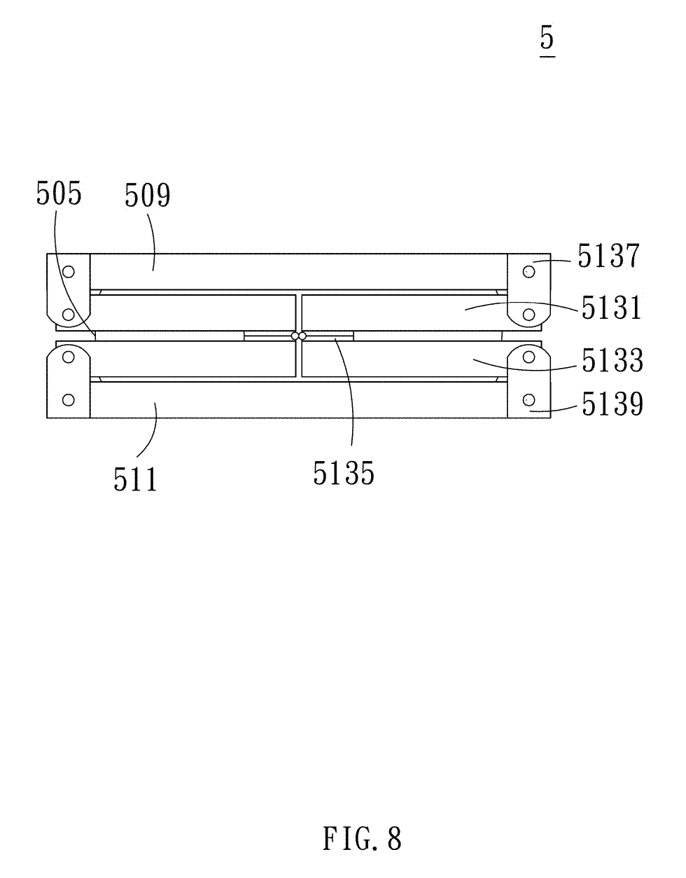

As shown in FIG. 7 and FIG. 8, the supporting unit 513 pivots on the first pivoting member 5135 and thus achieving the effect of folding the cover device 5.

Before photographing the ColorChecker 3 to acquire the first ColorChecker image, the ColorChecker 3 is first placed in the accommodating space 507 of the cover device 5. The cover device 5 can isolate external light sources and form a dark environment. Then the lamp 503 can generate a standard light source to illuminate the ColorChecker 3. In the step S1, the camera unit 11 of the mobile device 1 photographs the ColorChecker 3 through the hole 501 for acquiring the first ColorChecker image.

By using the present embodiment, the ColorChecker 3 is placed in the cover device for reducing the interference of external unstable light sources. Besides, the cover device 5 is foldable and hence convenient for carrying by users. When the mobile device 1 and the cover device 5 work together, the hues of the ColorChecker 3 can be acquired using the mobile device 1 and the cover device 5 at arbitrary places. No darkroom environment is required. Thereby, the convenience of acquiring the ColorChecker 3 is improved and the cost is reduced.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A method for measuring hue using a mobile device, comprising steps of:
photographing a ColorChecker using a camera unit of a mobile device to give a first ColorChecker image, and said ColorChecker including a plurality of color blocks;
said mobile device converting the color space of said first ColorChecker image using a color-space conversion algorithm, and giving a second ColorChecker image; and
said mobile device acquiring the pixel values of each said color block in said second ColorChecker image.

2. The method for measuring hue using a mobile device of claim 1, and before said step of photographing said ColorChecker using said camera unit of said mobile device to give said first ColorChecker image, further comprising a step of said mobile device aligning said ColorChecker according to a plurality of alignment marks on said ColorChecker.

3. The method for measuring hue using a mobile device of claim 1, and after said step of said mobile device acquiring the pixel values of each said color block in said second ColorChecker image, further comprising steps of:
transmitting the pixel values of each said color block to a server;
said server acquiring a piece of description information of color characteristics using an algorithm according to the pixel values of each said color block; and
transmitting said description information of color characteristics to said mobile device.

4. The method for measuring hue using a mobile device of claim 1, wherein said ColorChecker is printed by a printing apparatus.

5. The method for measuring hue using a mobile device of claim 1, wherein said first ColorChecker image belongs to the RGB color space.

6. The method for measuring hue using a mobile device of claim 1, wherein said second ColorChecker image belongs to the CIE XYZ color space.

7. The method for measuring hue using a mobile device of claim 1, wherein said first ColorChecker is placed in a cover device; and said camera unit of said mobile device photographs said ColorChecker through a hole of said cover device.

8. The method for measuring hue using a mobile device of claim 7, wherein said cover device comprises a lighting device inside.

9. A cover device, comprising:
a base;
a lid, including a hole, including one or more lamp on one surface, located above said lid, connected with said base via a plurality of supporting units, each of said plurality of supporting units including a first supporting member and a second supporting member, one end of said first supporting member connected with one end of said second supporting member via a first pivoting member, the other end of said first supporting member connected with said lid via a second pivoting member, and the other end of said second supporting member connected with said base via a third pivoting member;
a hood, disposed between and connected with said base and said lid; and
an accommodating space, formed in said cover device.

10. The cover device of claim 9, wherein a ColorChecker is place in said accommodating space.

11. The cover device of claim 9, wherein said cover device is made of opaque and flexible materials.

12. The cover device of claim 9, wherein said one or more lamp can emit light with a color temperature of D50 or D65.
